(19) United States
(12) Patent Application Publication
(10) Pub. No.: US 2006/0024492 A1
(43) Pub. Date: Feb. 2, 2006

(54) Packaging for solid product release

(75) Inventors: Brady Walz, Inver Grove Heights, MN (US); Robert J. Ryther, St. Paul, MN (US)

Correspondence Address: ECOLAB INC., MAIL STOP ESC-F7, 655 LONE OAK DRIVE, EAGAN, MN, 55121, US

(73) Assignee: ECOLAB INC., St. Paul, MN (US)

(21) Appl. No.: 10/909,470

(22) Filed: Aug. 2, 2004

(51) Int. Cl. B32B 18/00

(52) U.S. Cl. 428/325

(57) ABSTRACT

The invention pertains to methods of releasing a product, and a solid product in particular, from a container. In one particular embodiment, the invention pertains to packaging to assist in the release of a product, and a solid product in particular, from a container. The packaging includes a flexible, durable liner material attached to the container. The container includes a vacuum release.

### FIELD OF THE INVENTION

The invention pertains to methods of releasing a product, and a solid product in particular, from a container. In one particular embodiment, the invention pertains to packaging to assist in the release of a product, and a solid product in particular, from a container. In this embodiment, the packaging includes a flexible, durable liner material attached to the container. The container includes a vacuum release.

### BACKGROUND

Solid products in the chemical industry present many advantages over using non-solid products. For example, solid products are less expensive to ship because they are usually formulated as concentrates that are then diluted on-site. Solid products can be formulated using aggressive chemistry that provides better cleaning including strong acids and strong bases. Solid products with such aggressive chemistry are generally considered safer than comparable non-solid or liquid products because a solid product cannot spill like a liquid product. Additionally, solid products can be dispensed into a dispenser without the user having to touch the solid product.

One method of dispensing a solid product without having the user touch the solid product is to place the solid product into a container. The container may be a flexible container such as a film, or the container may be a rigid container such as a tub. In some embodiments, it may be desirable for the solid product to remain in the container until the solid product is completely used up. However, in other embodiments, it may be desirable to have the solid product release from the container and fall into a dispenser. In such embodiments, it has been observed that the solid product does not readily release from the tub when the tub is turned upside down. Therefore, there is a need for packaging to assist in the release of a solid product from a container.

### SUMMARY

Surprisingly, it has been discovered that including a flexible, durable liner material attached to the container assists in the release of the solid product from the container when the container is turned upside down. It may be beneficial to provide the container with a vacuum release. These and other embodiments will be apparent to those of skill in the art and others in view of the following detailed description of some embodiments. It should be understood, however, that this summary, and the detailed description illustrate only some examples of various embodiments, and are not intended to be limiting to the invention as claimed.

### BRIEF DESCRIPTION OF THE DRAWINGS

FIG. 1 shows a container turned upside down having a liner and a solid product in the container.

FIG. 2 shows a container turned upside down having a liner and a solid product where the solid product has started to release from the container and the liner is starting to invert and pull away from the solid product.

FIG. 3 shows a container turned upside down having a liner and a solid product where the solid product is almost completely released from the liner and the liner has completely inverted.

FIG. 4 is an example of a liner with a uniform thickness throughout the liner.

FIG. 5 is an example of a liner with a step near the top of the liner having a greater thickness than the rest of the liner.

### DETAILED DESCRIPTION OF SOME EMBODIMENTS

As discussed above, the invention generally relates to packaging to assist in the release of a product, and a solid product in particular, from a container. The packaging includes a flexible, durable liner material attached to the container. The container includes a vacuum release.

Definitions

For the following defined terms, these definitions shall be applied, unless a different definition is given in the claims or elsewhere in this specification.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the term “about” may include numbers that are rounded to the nearest significant figure.

Weight percent, percent by weight, % by weight, wt %, and the like are synonyms that refer to the concentration of a substance as the weight of that substance divided by the weight of the composition and multiplied by 100.

The recitation of numerical ranges by endpoints includes all numbers subsumed within that range (e.g. 1 to 5 includes 1, 1.5, 2, 2.75, 3, 3.80, 4 and 5).

As used in this specification and the appended claims, the singular forms “a,” “an,” and “the” include plural referents unless the content clearly dictates otherwise. Thus, for example, reference to a composition containing “a compound” includes a mixture of two or more compounds. As used in this specification and the appended claims, the term “or” is generally employed in its sense including “and/or” unless the content clearly dictates otherwise.

Solid Product

The present invention may be used with any solid product. It is understood that the phrase “solid product” includes solid products, substantially solid products, semi-solid products, and the like. The solid product may be formed in any desired manner including cast methods, and extrusion. The solid product may be used for a variety of purposes including as a warewashing detergent, as a warewashing rinse aid, vehicle care detergent such as in a car wash, as a medical instrument detergent, as clean-in-place (CIP) cleaner, and the like. The solid product may include a variety of different chemistries including acids, bases, hardening agents, sequestering agents, surfactants, builders, enzymes, and the like. Some examples of solid products that may be used with the present invention are described in U.S. Pat. Nos. 6,602,350, 6,726,779, and 6,645,924 and U.S. patent application Ser. No. ______ (Attorney Docket Number 163.1951US01), filed on Aug. 2, 2004 directed to a Solid Detergent Compositions and Methods for Manufacturing and Using. The solid product may be poured directly into the liner material and allowed to harden in the liner. The product may harden by chemical reaction or temperature change. Alternatively, the solid product may be allowed to harden first and then placed in the liner. The solid product may be a variety of sizes. For example, the solid product may weigh from about 0.1 pound to about 1,000 pounds, from about 1 pound to about 100 pounds, and from about 1 pound, to about 30 pounds. The weight of the solid product is preferably at least about 2 pounds.

Liner Material

The invention includes a liner attached to a container to provide for the release of a solid product from the container. The liner material is preferably flexible enough to be able to invert on itself. Further, the liner material is preferably durable enough to support the weight of the solid product without tearing when the liner material is inverted. If the liner material tears, the liner may detach from the container and fall into the dispenser with the solid product which may lead to problems with the dispenser. The liner material is preferably able to be attached to the container. Finally, the liner material preferably does not adversely react with the chemistry of the solid product.

The liner material may be any material that meets the above requirements. Examples of suitable liners include polyolefins such as polyethylene HDPE (high density polyethylene), LDPE (low density polyethylene), and LLDPE (linear low density polyethylene), EVA (ethylene vinyl acetate), EMA (ethylene methyl acrylate), EAA (ethylene acrylic acid), EMAA (ethylene methacrylic acid), and polypropylene. Other suitable liners include polymers used in packaging such as nylon, PET, PVC, PVdC, EVOH, polyurethane, barex, and polystyrene. A person skilled in the art will be able to select a suitable liner material that meets the needs of this invention.

The liner may be one layer or multiple layers. If the liner is multiple layers, the multiple layers may be the same material or different materials. The liner may include a slip agent in the liner. The liner may be coated on the inside where the liner contacts the solid product. For example, the liner may be coated with a composition that prevents the reaction of the solid product with the liner. Further, the liner may be coated with a coating to assist in the release of the product from the liner or reduce the coefficient of friction between the liner and the solid product. Suitable coatings include liquids and powders including organic and inorganic oils and greases and silicates. Preferred coatings do not adversely react with the solid product. In addition, the liner may be used to add a material to the product. For example, the liner may be coated with a composition that becomes part of the solid product when the solid product is added to the liner and then dispensed with the solid product.

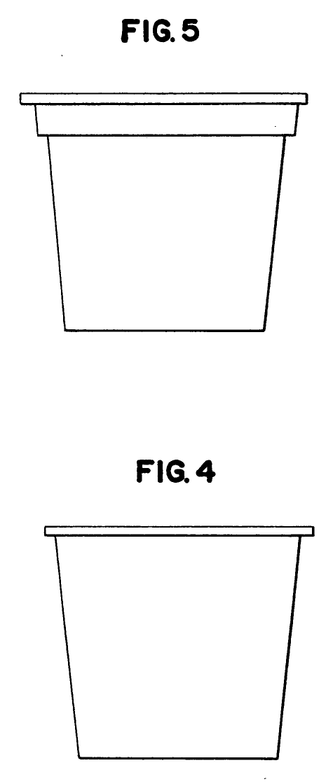

The liner has a thickness associated with it. The liner thickness may be uniform throughout the liner as shown in FIG. 4, or the thickness may vary in different parts of the liner as shown in FIG. 5. In an embodiment, the liner is as thin as possible while still being able to support the solid product and not break or tear when dispensing the solid product, or melt when hot product is poured in the liner to solidify. The liner thickness may range from about 1 mil to about 100 mils, from about 1 mil to about 50 mils, and from about 1 mil to about 10 mils. In an embodiment, the liner is thicker at the top, near the top of the container. For example, the liner may include a step near the top of the container as shown in FIG. 5. The step aids in helping the liner invert on itself. Without the step the liner may bunch up and prevent the solid product from releasing.

In an embodiment, the liner may be designed so that it does not allow light to pass through. This embodiment may be advantageous if the solid product adversely reacts to light. In an embodiment, the liner may be designed so that it does not allow air to pass through. This embodiment may be advantageous if the solid product adversely reacts to air.

For the present invention, the liner is attached to the container. The liner may be attached to the container in a variety of ways. The liner is preferably attached to the container near the rim of the container or the terminal end of the container open to the air such that when the container is inverted and the solid product is allowed to be released out of the liner, the liner is allowed to invert and hang freely from the container with an attachment near the rim or terminal end of the container. The liner is preferably not attached anywhere in the container, except for near the rim or terminal end. The liner may be attached to the container through welding, gluing, heat sealing, snapping, clamping, and the like. The liner may be completely attached to the container at the rim or the liner may be intermittently attached at the rim. If the liner is intermittently attached to the rim, the unattached portions will provide a vacuum release allowing the liner to pull away from the container and release the solid product.

Container

The liner material is attached to a substantially rigid container. The container is typically a plastic tub, however, the container may be made out of any substantially rigid material including corrugated fiberboard, formed paperboard, plastic, metal, glass, and the like.

In an embodiment, the container may substantially surround the solid material. For example, the container may have a wall having a generally conical shape, a terminal end open to the air, and an opposite end forming a bottom of the container. The terminal end, or rim, allows the solid product to pass through the rim and into a dispenser. When the container substantially surrounds the solid product except on the terminal end, the liner would preferably include a vacuum release. In an embodiment, the container may partially surround the solid material, and provide a vacuum release to allow the solid product to pull away from the liner. For example, the container may have a hole provided somewhere in the container, such as in the bottom of the container. The container may not have a bottom surface. The container may have partial walls. The container may merely be a rim for the liner material to attach to.

The container may be treated with a coating to help the liner pull away from the container. Suitable coatings include liquids and powders including organic and inorganic oils and greases and silicates. Preferred coatings do not adversely react with the solid product. However, coatings may be used to provide a beneficial reaction with the solid product.

Product Release

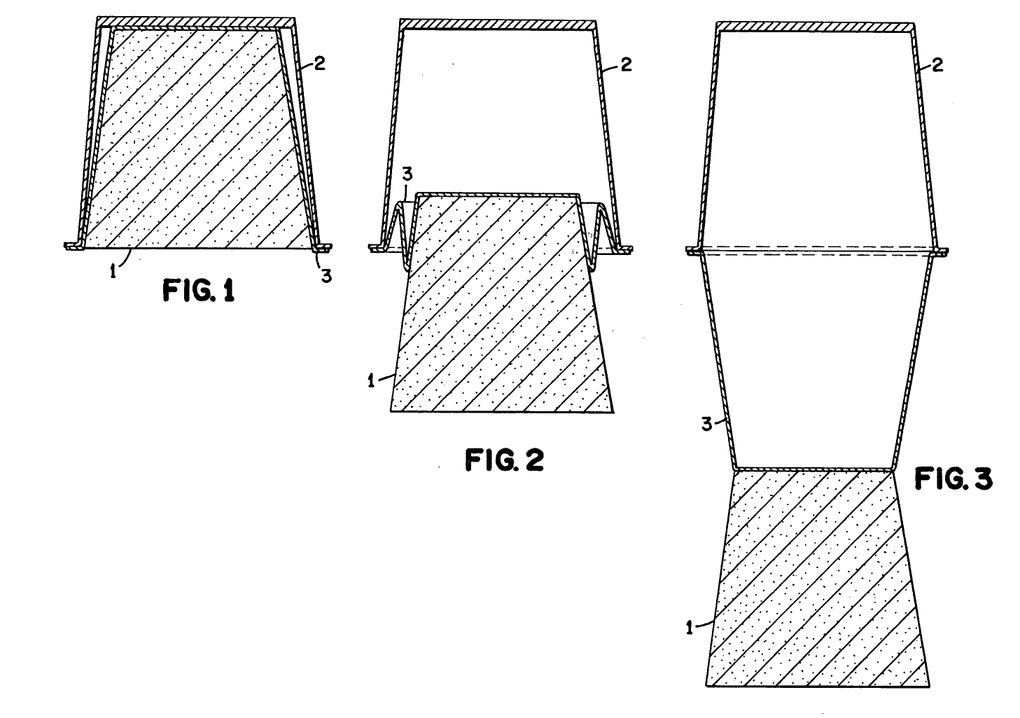

As discussed, the present invention provides for a method to release a solid product from a container using a liner. According to the invention, when the container is turned upside down into a dispenser in order to release the solid product, gravity pulls the solid product causing the liner to pull away from the container. The solid product preferably has enough mass in order to cause the liner to pull away from the container and invert and eventually for the solid product to completely pull away from the lienr and fall into a dispenser. FIG. 1 shows the solid product 1 in a container 2 having a liner 3. The container 2 is turned upside down to allow the solid product 1 to start releasing from the container 2 and the liner 3. As shown in FIG. 2, as the liner 3 pulls away from the container 2 and starts to invert, the liner 3 begins to peal away from the solid product 1. Eventually, the liner 3 completely peals away from the solid product 1, releasing the solid product 1 from the liner 3 and container 2 and into the dispenser. This is shown in FIG. 3.

For a fourteen pound (14 lb) product, the amount of time that it takes for the solid product to completely release from the liner should be relatively short. In an embodiment, the amount of time is less than five minutes, in an embodiment less than 1 minute, in an embodiment less than 10 seconds, and in an embodiment less than 3 seconds. It is understood that since the present invention may be used with solid products of any size, the amount of time that it takes for a solid product to release from the liner will vary depending on the size of the product. The amount of time necessary to release the solid product may be decreased by adding a coating to the container or the liner as previously discussed.

Other Release Methods

In addition to the use of a liner to assist in releasing a solid product from a container, several other methods of release may be used either alone or in conjunction with a liner to help release the solid product. For example, extruding a product and allowing it to cool before placing it in a container, with or without a liner, aids in release the product from the container. Also, rapidly heating a solid product in the container, thereby causing a thin layer of product to melt, aids in release the solid product when the container is turned upside down. Further, injecting high pressure air into the bottom of a container turned upside down or placing pressure on the container containing a solid product assists in the release of the solid product.

For a more complete understanding of the invention, the following examples are given to illustrate some embodiment. These examples and experiments are to be understood as illustrative and not limiting. All parts are by weight, except where it is contrarily indicated.

### EXAMPLES

### Example 1

Example 1 tested the impact of the following variables on product release: (1) having a hole in the container; (2) including a step in the liner; and (3) how the solid product was poured into the liner. For this example, an HDPE tub was used with a LDPE liner ultrasonically welded to the tub. An approximately fourteen pound sample of vehicle car wash, soon to be commercially available from Ecolab Inc. under the name Solid Gold was poured in the liner and allowed to set. The results are described in Table 1.

TABLE 1
Impact of Various Factors on Solid Product Release

| Hole in Tub | Liner | Fill | Solid Product Release Results |
|---|---|---|---|
| Yes | Step | Sloppy | Easy and quick. Solid product |
| | | | started releasing immediately |
| | | | when turned over. |
| No | No Step | Good | Tough. Solid product released |
| | | | initially but got stuck. Needed |
| | | | jostling for the solid product |
| | | | to pop-out. |
| Yes | Step | Sloppy | Easy and quick. Solid product |
| | | | started releasing immediately |
| | | | when turned over. |
| Yes | Step | Sloppy | Easy and quick. Solid product |
| | | | started releasing immediately |
| | | | when turned over. |
| No | No Step | OK | Tough. Solid product released |
| | | | initially but got stuck. Needed |
| | | | jostling for the solid product |
| | | | to pop out. |
| No | No Step | OK | Tough. Solid product released |
| | | | initially but got stuck. Needed |
| | | | jostling for the solid product |
| | | | to pop out. |
| Yes | Step | Sloppy | Easy and quick. Solid product |
| | | | started releasing immediately |
| | | | when turned over. |
| Yes | Step | OK | Easy and quick. Solid product |
| | | | started releasing immediately |
| | | | when turned over. |
| Yes - but | Step | Sloppy | Solid product initially released |
| covered with | | | but stopped. The solid product |
| tape. | | | immediately released when the |
| | | | hole was opened. |
| Yes - but | Step | Sloppy | Solid product initially released |
| covered with | | | but stopped. The solid product |
| tape. | | | did not pop out when the hole was |
| | | | opened and it needed two light |
| | | | punches. |
| Yes | No Step | Sloppy | Solid product initially released |
| | | | but stopped. It needed a few light |
| | | | punches to release. |
| Yes | No Step | Sloppy | Easy and quick. Solid product |
| | | | started releasing immediately |
| | | | when turned over. |
| Yes | Step | OK | Easy and quick. Solid product |
| | | | started releasing immediately |
| | | | when turned over. |

Example 1 shows several things. First, the hole in the bottom of the container was necessary to ensure the release of the solid product without jostling of the tub. Without the hole, the solid product would get stuck when it was about half way out. The solid product would still release but some jostling of the tub was necessary to break the vacuum. Second, including a step in the liner to make the profile of the container improved the solid product release and prevented thick material at the top of the liner from bunching up and making the product release difficult. Including the step in the liner allowed the product to release immediately when the container was turned upside down. This was much quicker than when a liner without a step was used. Finally, a sloppy fill did not affect the solid product release.

The foregoing summary, detailed description, and examples provide a sound basis for understanding the invention, and some specific example embodiments of the invention. Since the invention can comprise a variety of embodiments, the above information is not intended to be limiting. The invention resides in the claims.

What is claimed is:

1. A packaging apparatus comprising:
a. a substantially rigid container;
b. a liner located inside the container and attached to the container near the rim of the container; and
c. a substantially solid product wherein the liner substantially surrounds the solid product except on one side and the packaging includes a vacuum release.

2. The packaging apparatus of claim 1, wherein the container comprises a material selected from the group consisting of paperboard, plastic, metal, and glass.

3. The packaging apparatus of claim 1, wherein the liner is a plastic liner.

4. The packaging apparatus of claim 1, wherein the liner is welded to the container.

5. The packaging apparatus of claim 1, wherein the liner is glued to the container.

6. The packaging apparatus of claim 1, wherein the liner is heat sealed to the container.

7. The packaging apparatus of claim 1, wherein the liner is snapped to the container.

8. The packaging apparatus of claim 1, wherein the solid product is selected from the group consisting of a warewashing detergent, a warewashing rinse aid, a vehicle care detergent, a medical instrument detergent, and a clean-in-place detergent.

9. The packaging apparatus of claim 1, wherein the vacuum release is a hole in the container.

10. The packaging apparatus of claim 1, wherein the liner is a single layer of material.

11. The packaging apparatus of claim 1, wherein the liner is multiple layers of material.

12. The packaging apparatus of claim 1, wherein the liner further comprises a coating.

13. The packaging apparatus of claim 12, wherein the coating decrease the coefficient of friction between the liner and the solid product.

14. A method of dispensing a substantially solid product comprising:
a. providing a substantially rigid container comprising:
i. a liner located in the container and attached to the container; and
ii. a substantially solid product;
wherein the liner substantially surrounds the solid product and the container includes a vacuum release;
b. turning the container upside down; and
c. allowing the solid product to peal away from the liner.

15. The method of claim 14, wherein the container comprises a material selected from the group consisting of fiberboard, paperboard, plastic, metal, and glass.

16. The method of claim 14, wherein the liner is a plastic liner.

17. The method of claim 14, wherein the liner is welded to the container.

18. The method of claim 14, wherein the liner is glued to the container.

19. The method of claim 14, wherein the liner is heat sealed to the container.

20. The method of claim 14, wherein the liner is snapped to the container.

21. The method of claim 14, wherein the solid product is selected from the group consisting of a warewashing detergent, a warewashing rinse aid, a vehicle care detergent, a medical instrument detergent, and a clean-in-place detergent.

22. The method of claim 14, wherein the vacuum release is a hole in the container.

23. The method of claim 14, wherein the liner is a single layer of material.

24. The method of claim 14, wherein the liner is multiple layers of material.

24. The method of claim 14, wherein the liner further comprises a coating.

25. The method of claim 24, wherein the coating decrease the coefficient of friction between the liner and the solid product.
